(19) United States
(12) Patent Application Publication
(10) Pub. No.: US 2005/0084131 A1
(43) Pub. Date: Apr. 21, 2005

(54) Loudspeakers

(76) Inventors: Julian Fordham, Huntingdon (GB); Martin Colloms, London (GB); Russ Brown, San Francisco, CA (US)

Correspondence Address: FOLEY AND LARDNER;SUITE 500, 3000 K STREET NW, WASHINGTON, DC, 20007, US

(21) Appl. No.: 10/476,695

(22) PCT Filed: May 1, 2002
(86) PCT No.: PCT/GB02/01985

(30) Foreign Application Priority Data
May 11, 2001 (GB) 0111677.1
Mar. 6, 2002 (GB) 0205246.2

(51) Int. Cl. H04R 1/00; H04R 25/00; H04R 11/02

(52) U.S. Cl. 381/431; 381/423; 381/152; 381/424

(57) ABSTRACT

A method of making an acoustic member for a loudspeaker having an operative frequency range and acoustic output which depends on the values of parameters of geometry, bending stiffness, areal mass distribution, damping, tension modulus, compression modulus and shear modulus of the member, the method comprising providing an acoustic member having at least one frequency dependent parameter with a variation which depends on frequency, selecting the variation which depends on frequency, selecting the variation of the frequency dependent parameter to effect a desired acoustic output from the loudspeaker and making the member having said selected variation. The method may comprise selecting an acoustic member having a component made from a frequency dependent material which has a glass to rubber transition Tg in the operative frequency range of the speaker.

### TECHNICAL FIELD

The invention relates to loudspeakers and more particularly to bending wave panel-form loudspeakers, e.g. of the kind described in WO97/09842.

### BACKGROUND ART

A bending wave loudspeaker typically consists of an acoustic panel and at least one exciter mounted to the panel. The panel may be supported on a frame by a compliant edge termination which isolates the vibrating panel from the frame. The mechanical properties of the panel, edge termination and exciter mounting effect the acoustic performance of the loudspeaker.

It is known in the field of bending wave panels that the bending wave behaviour of a panel may be adjusted by manipulating sets of co-operative parameters. As taught in WO97/09842, the values of physical parameters of geometry, bending stiffness, areal mass distribution and damping of the panel may be selected to effect a desired distribution of resonant bending wave modes. The panel may be designed to be effective over a wide frequency range, maybe up to 8 octaves, by selecting a relatively large panel of good quality materials. However, the bandwidth of a bending wave panel loudspeaker may be limited as a result of the conflicting requirements for achieving good performance at both high and low frequencies. In general, better high frequency performance is achieved by using a light, stiff panel having low damping and high shear properties, whereas better low frequency performance is achieved by using a panel of lower stiffness and higher density.

The high frequency radiation efficiency may be improved by placing the coincidence frequency in the operative bandwidth of the loudspeaker, even in the lower portion of the operative bandwidth. This may be achieved by ensuring the panel has a high bending stiffness, since coincidence frequency is reciprocally proportional to stiffness. However, raising the bending stiffness of the panel reduces the low frequency capability of the panel, which may be countered by increasing the area and/or area mass density of the panel. Alternatively, damping may be added to control and smooth the low frequency response, particularly in operative regions where there is low modal density. However, such damping may reduce the output particularly at higher frequencies.

### DISCLOSURE OF INVENTION

Another conflicting requirement which needs to be considered is the desire to achieve both effective and extended high frequency performance. As discussed above, good high frequency performance is achieved by a panel of low density and high stiffness. However, this results in a panel having a relatively high mechanical impedance and thus more force is required to drive the panel to a useful loudness.

According to a first aspect of the invention, there is provided an acoustic member for a loudspeaker having an operative frequency range, characterised in that the member comprises a component made from a frequency dependent material having at least one parameter which varies as a function of frequency. The parameter may be selected from the group consisting of damping, bending stiffness, tension modulus, compression modulus and shear modulus. Since there may be interaction between the parameters, varying one or more parameters may affect other parameters.

The loudspeaker may be a bending wave loudspeaker comprising an acoustic radiator which supports bending wave vibration and a transducer mounted by a suspension to the acoustic radiator to excite bending wave vibration in the radiator to produce an acoustic output. The acoustic member may be the acoustic radiator and may be in the form of a panel, for example a distributed mode panel that supports resonant bending wave modes distributed in frequency over at least part, preferably all, of the operative frequency range.

The acoustic member may be a suspension for attaching the loudspeaker on a support, stand or wall and the frequency dependent material may be used to control unwanted vibration from the coupling of the acoustic member on the suspension.

The acoustic member may be a suspension which supports an acoustic radiator in a frame or baffle. The suspension may extend around the perimeter of the radiator or may be applied at particular positions on the radiator. The acoustic member may be the transducer suspension which supports the transducer on the acoustic member or may be a transducer suspension which supports the transducer on the frame. For example, the transducer may be an inertial moving coil exciter having a voice coil directly bonded to the acoustic radiator frequency-dependent material and a magnet assembly mounted to the coil by a resilient suspension which may be the component having a frequency dependent parameter. Alternatively, the acoustic member may be in the form of at least one small mass mounted on the acoustic radiator, e.g. a mass-loaded polymer foam pad.

Thus for a bending wave loudspeaker, the acoustic member may be selected from the acoustic radiator, the transducer suspension, the radiator suspension or masses mounted on the acoustic radiator. The use of frequency-dependent material is not limited to use as part of the panel of a distributed mode loudspeaker.

The loudspeaker may be a pistonic loudspeaker comprising an acoustic radiator in the form of a cone mounted on a frame by a compliant edge termination, a drive unit supported on the frame by a spider and an enclosure housing the cone and drive unit. The acoustic member may be incorporated in the spider or may be the compliant edge termination. Alternatively, the acoustic member may be the cone or a compliant suspension which couples the drive unit to the enclosure.

The parameter which varies as a function of frequency may be bending stiffness and may be lower at low frequencies (i.e. below 1 kHz) than at high frequencies (above 1 kHz). The bending stiffness is preferably at least 20% lower at low frequencies than at high frequencies.

For an acoustic member in the form of a bending wave panel, the fundamental frequency (F0) calculated from equation 1 in the appendix gives an approximation to the low frequency limit. Since F0 is directly proportional to bending stiffness, an acoustic member having lower stiffness at low frequencies may have an extended low range performance for a given size.

High frequency performance may also be improved by addressing the known “aperture effect” in which a secondary resonance develops within the diameter of a coil of a moving coil transducer mounted on an acoustic radiator. The aperture resonance frequency F_{R} is determined from the bending wave resonance frequency F_{B} and the shear wave resonance frequency F_{S} using equations 2 to 4 in the appendix.

Since F_{B} and thus F_{R} is dependent on bending stiffness, a bending wave panel having higher stiffness at higher frequencies may have an aperture resonance frequency occurring at a higher frequency and thus may have an extended high range performance. Thus, the invention may provide a bending wave panel having lower bending stiffness at low frequencies and higher bending stiffness at high frequencies whereby a broader frequency range than a member having a constant bending stiffness is achieved. The bending stiffness may be at least 20% higher at high frequencies (i.e. above 1 kHz) than at lower frequencies (i.e. below 1 kHz). The efficiency of the panel may also be improved in certain regions of the frequency range.

The bending stiffness may rise steadily with increasing frequency and thus may be directly proportional to frequency. Alternatively, the bending stiffness may have a relatively sharp transition at a selected point in the frequency range. In this way, the acoustic member may be considered to act as two independent low and high frequency acoustic members. For example, for an acoustic member in the form of a bending wave acoustic radiator, the parameters may determine the natural resonant frequencies and the useable frequency range for the low frequency member. Whereas for the high frequency member, the greater stiffness may allow efficient working to the highest required frequency, and may allow a desired coincidence frequency to be set.

The parameter which varies as a function of frequency may be compliance. For an acoustic member in the form of a compliant edge termination around a cone in a pistonic speaker, the termination may have high compliance at low frequencies and a lower compliance at high frequencies. In this way, movement of the cone at low frequencies will be largely unimpeded and simultaneously at higher frequencies, the acoustic energy will be better terminated whereby reflection interference may be minimised. The cone may have variable compliance, for example by appropriate choice of the polymer blend or by treating the cone after manufacture. The cone may have high damping at low frequency and enhanced stiffness at higher frequencies which may be used to enhance speaker performance. The damping may be at least 20% higher at high frequency than at low frequency and the stiffness may be at least 20% greater at high frequency than at low frequency.

It is known that the use of a compliant suspension between the coil and magnet assembly of the transducer of a bending wave speaker may lead to a transducer resonance in the low frequency range of the speaker. This is known as the inertial resonance. The compliant suspension may have high damping whereby the amplitude of the resonance may be broadened and/or the resonance may be selectively tuned to a specific frequency. In this way, improved low frequency performance may be achieved. Similarly, the damping of the compliant transducer suspension between the transducer and the frame may be selected to broaden the amplitude of or change the frequency of this fundamental resonance of the transducer.

The parameter which varies as a function of frequency may be damping. The damping of a material may be dependent on the chemistry, polymer formation and/or specific loss mechanisms within the material. The damping may rise or fall with increasing frequency whereby refinement of acoustic performance may be achieved. The damping may be applied over all or part of the acoustic member. EP 0 621 931 B1 describes the use of damping materials which have high damping factors at specific temperature ranges and such material may be altered to have damping which varies as a function of frequency.

An acoustic member in the form of a mass may be positioned to couple to specific mode(s) in an acoustic radiator. The mass may have high damping at low frequency and low damping at high frequency whereby a specific low frequency resonant mode may be effectively damped without greatly effecting high frequency resonant modes. A similar effect may be achieved by using an acoustic member in the form of an acoustic radiator having frequency dependent material applied at specific positions inside the structure of the acoustic radiator, e.g. at the transducer location. For example, the acoustic radiator may comprise a honeycomb core having frequency dependent material injected into specific cells. Alternatively, the surface of the acoustic member may have regions of frequency dependent material which may be arranged in rectangular, triangular or polygonal block format or in a concentric format.

An acoustic member in the form of a bending wave acoustic radiator may have a higher level damping, i.e. at least 20% greater, at a particular frequency whereby the distribution of modes around that particular frequency is improved. Increasing the damping results in broader resonant modes which may distribute the modes more evenly in frequency. Thus, a smoother response may be obtained around that particular frequency.

The acoustic member may comprise more than one frequency dependent parameter. For example, an acoustic member in the form of a radiator suspension extending around the perimeter of a bending wave acoustic radiator may have low damping and low compliance at higher frequencies and high damping and high compliance at lower frequencies. Increasing the level of damping may broaden the low frequencies modes and may thus improve modal spread at low frequencies. Increasing the level of damping may also increase the absorption of bending wave vibration at the boundary. This may be particularly useful for an acoustic radiator which has low damping since this may control reverberation of the radiator. By increasing the compliance at low frequencies, the acoustic radiator may be generally freely suspended and the low frequency modes of the acoustic radiator are shifted to lower frequencies. By decreasing the compliance at high frequencies, the acoustic radiator may be generally clamped or boundary terminated whereby the high frequency modes of the acoustic radiator are shifted to lower frequencies.

The effect and advantages of clamping and boundary termination are explained in WO99/52324 to New Transducers Ltd. However, edge control can also reduce the low frequency output. Thus, by using a frequency-dependent material, an advantageous combination of properties can be obtained.

The acoustic member may be a composite structure comprising at least two components. Only one component or alternatively all components in the composite structure may have a frequency dependent parameter. In this way, the parameters of the components individually or in combination may be selected to enhance performance. For example, the acoustic member may have a sandwich or laminate construction. Thus the member may comprise a core of low density material (e.g. foam or honeycomb) and two skins adhered by adhesive layers to opposed faces of the core. The core, skins and/or adhesive layer may be made from a frequency dependent material having a frequency dependent parameter. The skins may be sprayed on or applied as a continuous film.

One advantage of using skins having frequency dependent parameter may be to counteract shear effects in some core materials. Such shear effects may significantly reduce the overall bending rigidity of the structure at high frequency and thus may limit performance in this bandwidth. Thus, by choosing skins which have bending stiffness increasing with frequency, rigidity of the panel may be maintained and thus high frequency performance may be improved.

Alternatively, the acoustic member may be a monolithic structure, i.e. one not being of core and skin construction, e.g. a structure made from solid polymers (e.g. polycarbonates, acrylics, polyesters), foamed plastics, metal, wood or felted paper. The monolithic structure may be made of frequency-dependent material which has a frequency dependent parameter.

For a monolithic panel, bending stiffness is directly proportional to the Young's modulus as set out in equation 5 in the appendix. Thus the frequency dependent parameter may be the Young's modulus (hereinafter modulus) of the frequency dependent material. Thus, as described above a broader bandwidth for an acoustic panel may be achieved by using a material which has a modulus which is lower at low frequency and higher at high frequency. The expression for bending stiffness for a composite structure, e.g. sandwich panel, is more complex but is still dependent on the modulus and thus modulus may be the frequency dependent parameter.

The acoustic member may comprise a surface layer having a frequency dependent parameter. The surface layer may be applied either as a spray coating or a film layer and may act as an anti-reflection coating for transparent applications. The surface layer may be applied to monolithic or sandwich members.

The frequency dependent material may be a viscoelastic material, i.e. a material possessing time-dependent properties. For example, viscoelastic materials have previously been used for vibration damping, acoustic attenuation or isolation purposes. Such materials and their methods of manufacture are, for example, described in WO93/15333 to Minnesota Mining and Manufacturing Company. Many viscoelastic materials have mechanical properties which change with frequency excitation and may thus be designed to have maximum energy absorption at a specific frequency.

The frequency dependent material preferably has a glass to rubber transition in which damping of the material has a sharp peak and storage modulus of the material drops by several, e.g. three, orders of magnitude. Such a transition may be regarded as critical in creating a degree of frequency dependence in the material. The transition preferably occurs in the operative frequency range of the speaker whereby energy absorption or damping may be maximised. The transition may occur in the temperature range −20° C. to 50° C. and at frequencies between 0.1 Hz to 1 kHz. The acoustic member may have separate regions each having transitions at different frequencies.

The frequency dependent material may be a resin e.g. polyurethane or epoxy, with a glass-to-rubber transition at a frequency within the required frequency range, whereby the material has low modulus or stiffness at low frequencies but higher modulus at higher frequencies. For an acoustic member in the form of a panel this should beneficially decrease the frequency of the lowest operational mode of the panel whilst enhancing the stiffness of the panel at higher frequencies.

The frequency dependent material may be a thermoplastic polymer having damping and/or other mechanical properties which depend on temperature and/or frequency. The frequency dependent material may be a foamed material, whereby a low density material with variable damping properties may be achieved. The foamed material may be used as a core or as small individual damping masses placed on another surface. The frequency dependent material may be a polymer blend from which the acoustic member is manufactured by injection moulding or extrusion.

The frequency dependent material may be used in combination with a non-frequency dependent material. The frequency dependent material may be a polymeric material which encapsulates a higher modulus fibre reinforcement such as carbon or glass fibres. Changes in the modulus of the polymeric material may result in a change of the overall modulus of the acoustic member which depends on the proportions of the fibre to the polymeric material and their relative properties. Alternatively, the polymeric material may encapsulate metal or ceramic, whereby the acoustic member may benefit from the high mass of the metal or ceramic and the variable damping of the polymeric material.

The acoustic member may be in the form of an acoustic radiator and may taper across its width and/or its length. The thickness of the radiator may increase or decrease from its centre to its perimeter. By decreasing the thickness, the central region of the acoustic radiator may be stiff and act as a bending wave acoustic radiator and the edge region may have higher compliance whereby the acoustic radiator may be mounted directly to a supporting frame, i.e. without a separate edge suspension. A similar effect may be achieved by other mechanisms which vary the modulus across the acoustic radiator.

The use of frequency dependent materials provides another parameter which may be used to improve performance of a speaker. Thus, according to a second aspect of the invention, there is provided a method of making an acoustic member for a loudspeaker having an operative frequency range and acoustic output which depends on the values of parameters of geometry, bending stiffness, areal mass distribution, damping, tension modulus, compression modulus and shear modulus of the member, the method comprising providing an acoustic member having at least one frequency dependent parameter with a variation which depends on frequency, selecting the variation of the frequency dependent parameter to effect a desired acoustic output from the loudspeaker and making the member having said selected variation.

The acoustic member may be selected to have a component made from a frequency dependent material which has a glass to rubber transition which preferably occurs in the operative frequency range of the speaker. The method may comprise modifying the frequency dependent material to adjust the temperature and/or frequency at which the transition occurs. The material may be a polymer and modifying the material may comprise modifying at least one of the parameters in the group consisting of molecular weight, (i.e. sum of the weight of all the atoms in a molecule divided by the number of molecules in a polymer), molecular distribution, steric effects (i.e. effects of side groups attached to polymer chain), polarity of side group and crosslink density. A plasticizer may be added to the polymer to lower the transition temperature.

The molecular weight may be increased to increase the transition temperature or vice versa. The distribution may be altered to increase the tendency to cause entanglement i.e. wrapping of chains around each other, and hence to increase the transition temperature or vice versa. Attaching a bulky or complex side group may increase the transition temperature or vice versa. For example substituting the hydrogen side group in Poly(cis-1,4)butadiene with a methyl group to give natural rubber (Poly(cis-1,4)isoprene) raises the transition temperature from −108° C. to −73° C.

Replacing a side group with an appropriately polarised (i.e. negative or positive) side group may increase secondary bonding with the main chain and hence increase the transition temperature or vice versa. For example, replacing the methyl group in natural rubber with a chlorine atom gives Polychloroprene (Neoprene®) and increases the transition temperature from −123° C. to −50° C., even though the methyl group is larger. These principles may be applied to design polymers which show a transition temperature having a value close to room temperature, i.e. above 21° C.

In some polymeric materials two adjacent molecules may form a strong bond, i.e. may be cross-linked. By increasing the number of and hence density of cross-links, the transition temperature may be raised or vice-versa. The control of cross-linking in polymers applies to all polymers which exhibit cross-linking, including a range of both thermoset and thermoplastic materials e.g. polyurethanes, epoxy resins, polyesters (unsaturated and saturated), bismaleimide resins, phenolics, vinyl esters.

The polymer may have regions of amorphous and crystalline structure, i.e. regions having a random entanglement of molecules and regions of regularly-packed, repeatable molecules, respectively. Such a polymer may have two transition temperatures, namely a glass transition and a crystalline melting temperature at which temperature the bonds in the crystalline structure break down. By adjusting the parameters of the regions having an amorphous structure, the transition temperature may be adjusted, provided the glass transition temperature remains lower than the melting point.

The polymer may be a copolymer consisting of two distinct monomers e.g. polypropylene and polyethylene. The transition temperature and/or frequency may be adjusted by altering the relative proportions of the two monomers and/or by arranging the two monomers in different ways, e.g. in alternating structure or in blocks of each monomer type, etc. The co-polymer may combine several different polymers each with high damping characteristics at different temperatures. Polymers which show high damping properties are described in the following reference Nielsen L. E. “Mechanical Polymers”.

Some small amplitude non linearities may result from the use of such frequency dependent materials which needs to be considered by a loudspeaker designer.

### BRIEF DESCRIPTION OF DRAWINGS

For a better understanding of the invention, and purely by way of example, specific embodiments of the invention will now be described with reference to the accompanying drawings, in which

FIG. 1 illustrates a distributed mode loudspeaker according to the invention;

FIG. 2 is a graph showing the variation in Young's modulus with frequency for the loudspeaker of FIG. 1 compared with a loudspeaker made according to the prior art;

FIG. 3 is a frequency response (acoustic pressure in dB against frequency Hz) for the loudspeakers of FIG. 2;

FIG. 4 a graph of stress σ and strain ε against sinusoidal force ωt for a material;

FIG. 5 is a graph showing both variation in storage modulus (log E′) and damping factor (d_{E}) against temperature which illustrates the glass to rubber transition;

FIG. 6 is a graph showing log of frequency against the inverse of temperature for a polymer;

FIG. 7 is a graph showing variation in storage modulus (log E′) and damping factor (d_{E}) against temperature for two different frequencies, and

FIG. 8 which is a graph of showing the variation of damping and storage modulus with frequency.

### BEST MODES FOR CARRYING OUT THE INVENTION

Referring to FIG. 1, a panel 11 is shaped to have a distribution of resonant bending wave mode in an operative frequency range of interest. The values of the parameters of the panel are chosen to smooth peaks in the frequency response caused by “bunching” or clustering of the modes. The resultant distribution of resonant bending wave modes, particularly low frequency modes, may thus be such that there are substantially minimal clusterings and disparities of spacing. The resonant bending wave modes associated with each conceptual axis of the panel-form member are arranged to be interleaved in frequency whereby a substantially even distribution may be achieved.

A transducer 13 is provided on the panel at a location for coupling well to the resonant bending wave modes, as described in WO97/09842, namely at a position (4/9Lₓ, 3/7L_{y}). Thus the transducer is at a location where the number of vibrationally active resonance anti-nodes is relatively high and conversely the number of resonance nodes is relatively low. The transducer is an electrodynamic exciter with a voice coil having a diameter of 25 mm.

The panel is a monolith made from PolyMethylMethacrylate (n-butyl) PMMA which is a material having a glass to rubber transition temperature T_{g} of 27° C. Thus the transition from glassy to rubbery behaviour begins to occur at room temperature (25° C.). The effect of such a transition is explained with reference to FIGS. 4 to 6. The parameters of the material are set out in the table below together with the parameters of polycarbonate which was used to make a second panel with the same dimensions, same transducer placement and same transducer type for comparative purposes.

| Material | Polycarbonate | PMMA |
|---|---|---|
| Density (ρ) kg m⁻³ | 1200 | 1160 |
| Young's Modulus (E) GPa | 2.3 | 1.9 |
| Damping Factor (d_{E}) @ 5 kHz | 0.011 | 0.051 |
| Glass Transition Temperature | 118 | 27 |
| (T_{g}) ° C. | | |

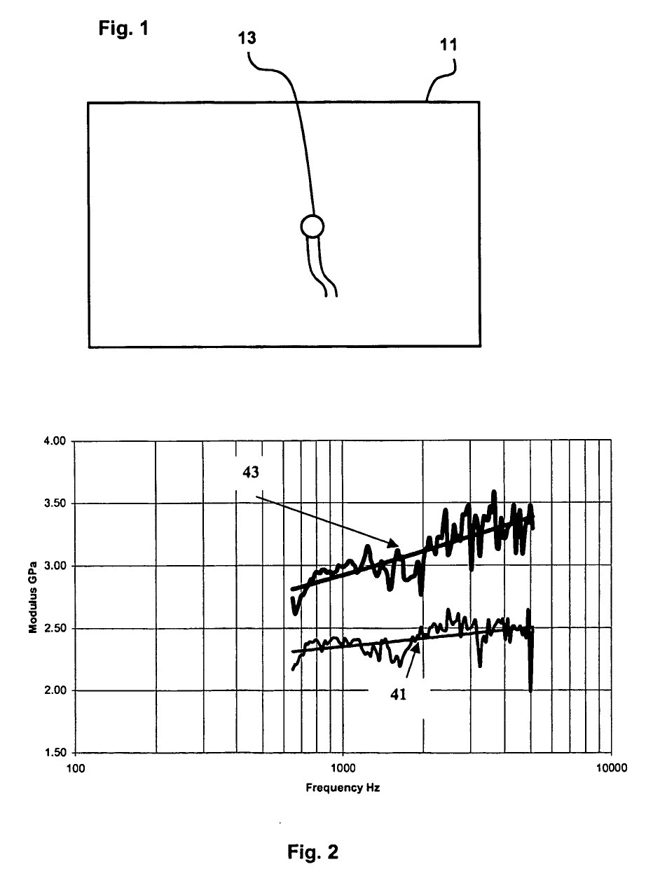

FIG. 2 shows the variation 43, 41 in Young's modulus with frequency for the loudspeakers made from PMMA and polycarbonate, respectively. The value of Young's modulus E is calculated by measuring the bending wave velocity c_{B} for each frequency and by applying equation 6.

FIG. 2 shows that the rate of increase of Young's modulus with frequency is greater for the PMMA panel than for the polycarbonate panel even though the polycarbonate panel has a greater static value of Young's modulus (2.3 GPA compared with 1.9 GPA). Thus, the PMMA panel has a higher Young's modulus at high frequencies than at low frequencies and has a higher Young's modulus at high frequencies than the polycarbonate panel.

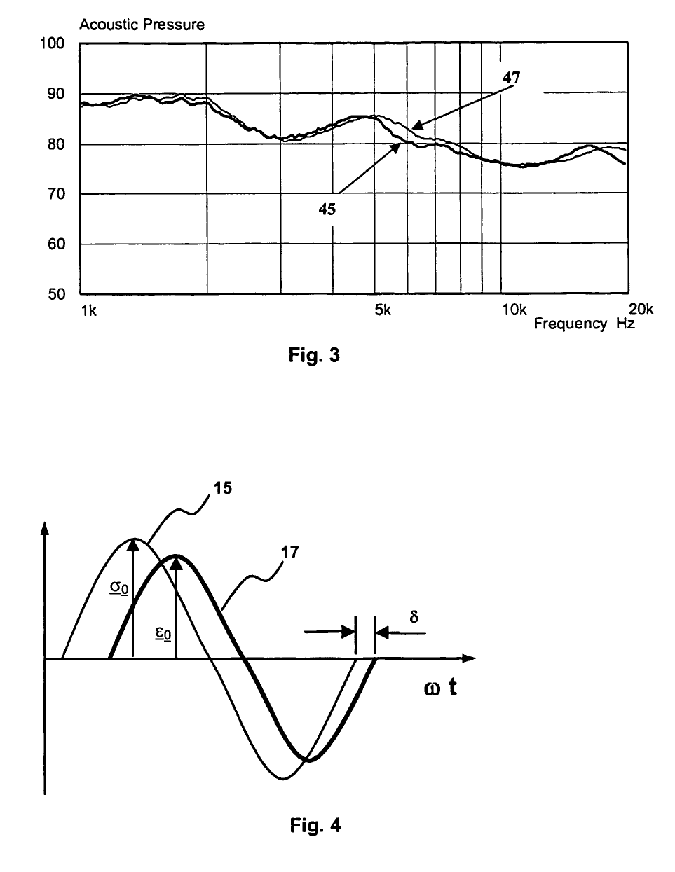

FIG. 3 shows the frequency responses 47, 45 for the loudspeaker using the PMMA panel and polycarbonate panel respectively. The aperture resonance for the loudspeaker using the PMMA panel occurs at a higher frequency than the aperture frequency for the loudspeaker using the PMMA panel, approximately 18.1 kHz compared to 16.04 kHz. Thus, the PMMA panel provides an increased high frequency limit compared to the polycarbonate panel which has a lower rate of increase of modulus with frequency.

The PMMA panel has static values for Young's modulus and density which are approximately 13% lower than the values for the polycarbonate panel. Thus, the modal frequencies would be expected to be correspondingly lower. However, as shown in FIG. 3, the local modal frequency for the PMMA panel is higher than for the polycarbonate panel which results from the greater change in Young's modulus with frequency for PMMA than for polycarbonate.

FIG. 4 shows the sinusoidal variation 15, 17 of the stress (σ) and strain (ε) in a viscoelastic material respectively as well as the phase lag parameter (δ) between the stress and strain components. The time lag component may be used to derive the damping or loss factor (η) as shown in Equation 7. Equation 7 also shows the relationship between the storage modulus E′ and the loss modulus E″ which represents the capability of the material to store or lose energy respectively and which are the real and imaginary parts of the complex Young's modulus respectively. The damping factor controls the degree of absorption of energy and is a material parameter which does not vary with dimensions for an isotropic homogeneous material. The complex Young's modulus determines the rigidity of a component.

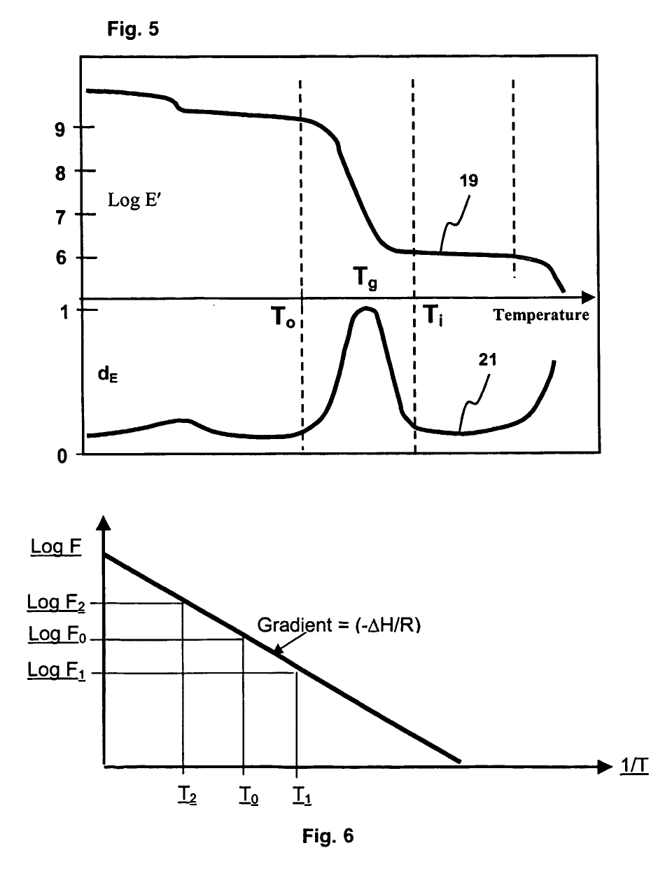

FIG. 5 shows the variation of damping factor 19,21 d_{E} and storage modulus E′ with temperature respectively for a thermoplastic polymer material at a fixed frequency. At low temperatures, i.e. below T₀, the material exhibits glassy behaviour. The material is stiff with a high storage modulus and a generally constant low damping factor. At higher temperatures, i.e. above T₁, the material exhibits rubbery behaviour. The material is more compliant, has a low storage modulus and a generally constant low damping factor. As the temperature increases further, i.e. above T₂ the material begins to flow.

The glass to rubber transition occurs between the temperatures To and T₁. During the transition there is a sharp drop in the value of the storage modulus and the damping factor rises sharply to a peak then falls sharply away. The maximum value of the damping factor occurs at the glass transition temperature T_{g}. At this temperature, the strain lags behind the stress by exactly the amount to cause maximum energy dissipation.

The variation of storage modulus with temperature may be equated to that of storage modulus with frequency. High temperatures are equivalent to low frequencies and high frequencies are equivalent to low temperatures.

The frequency at which the glass transition temperature occurs may be shifted from a reference frequency f₀ to another frequency f according to equation 8. Equation 8 may be rearranged and by plotting a graph of log f against the inverse of temperature as shown in FIG. 6. The activation energy for each transition process may be derived from the gradient of the graph. Since the graph has a constant gradient, the activation energy is constant, although this is only correct in the transition period. Thus, if the frequency is shifted from F₀ to a higher frequency F₂, there is a corresponding increase in the transition temperature from T₀ to T₂. If the frequency is decreased to F₁, there is a corresponding decrease in the transition temperature to T₁.

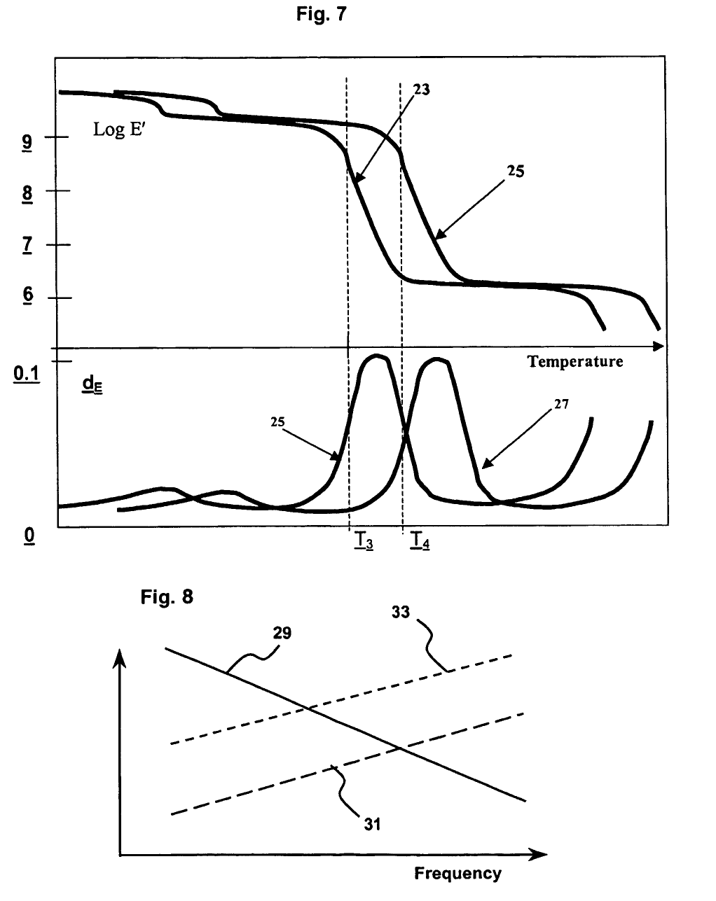

A shift in the frequency affects the storage modulus E′ and the damping factor d_{E}. This is illustrated in FIG. 7 which shows the variation 23,25 in storage modulus E′ at frequency F₀ and F₂ respectively and the variation 27,29 in damping factor d_{E} at frequency F₀ and F₂ respectively. By shifting the transition temperature T_{g} to a higher value, the value of the storage modulus is higher at any operating temperatures.

The change in damping factor is more complicated and shifting the transition temperature T_{g} to a higher value may lead to an increasing or decreasing damping factor depending on the operational temperature. At the operational temperature of T₃ the damping factor for the frequency F₂ is lower than for F₀ and is constant rather than increasing in value. However, at the operational temperature of T₄, the values of the damping factor are approximately equal but the damping factor is decreasing for F₀ and increasing for F₂.

This is illustrated in FIG. 8 which is a graph showing the variation 29,31 and 33 of damping and storage modulus with frequency. The damping may decrease with frequency as illustrated by variation 29 or may increase with frequency as illustrated by variation 31. The storage modulus increase with frequency as shown by variation 33. Thus, there are two possible options for the damping behaviour and stiffness of a panel manufactured using these materials:

Low stiffness/high damping at low frequencies but high stiffness/low damping at high frequencies.

Low stiffness/low damping at low frequencies but high stiffness/high damping at high frequencies.

Thus by changing the transition temperature or frequency for a particular polymer, the mechanical properties may be modified to achieve specific values of storage modulus and damping. These materials having designed variations in performance with frequency may be used to make panels and related components for acoustic devices and loudspeakers whereby improvements in frequency bandwidth and performance may be achieved.

### APPENDIX

$$F0 = \frac{π}{A} \sqrt{\frac{B}{μ}} \qquad Equation 1$$

where
F0: fundamental frequency (Hz)
A: panel area (m²)
B: average bending rigidity or stiffness (Nm)=½(Bₓ+B_{y})
μ: areal/surface density (kg m⁻²)

$${F}_{B} = \frac{1}{2 π} ( \frac{4.81}{{D}_{E}} ) \sqrt{\frac{B}{μ}} \qquad Equation 2$$

where
F_{B}: bending wave resonance frequency
D_{E}: exciter diameter

$${F}_{S} = \frac{1}{2 π} ( \frac{4.81}{{D}_{E}} ) \sqrt{\frac{Gt}{μ}} \qquad Equation 3$$

where:
F_{S}: shear wave resonance frequency
G: through thickness shear modulus

$${F}_{R} = \sqrt{\frac{{F}_{B}^{2} {F}_{S}^{2}}{{F}_{B}^{2} + {F}_{S}^{2}}} \qquad Equatio n 4$$

where:
F_{R}: cumulative resonant frequency

$$B = \frac{E {t}^{3}}{12 ( 1 - {v}^{2} )} \qquad Equation 5$$

where:
B: bending stiffness
t: thickness
E: Young's modulus (Pa)
v: Poisson's ratio

$${c}_{B} = \sqrt{ω} \sqrt{\frac{B}{μ}} \qquad Equation 6$$

where
C_{B}: bending wave velocity (m s⁻¹)
ω: frequency (rads)
B: bending rigidity (Nm)
μ: areal density (kg m⁻²)

$$η = tan δ = \frac{{E}^{″}}{{E}^{′}} \qquad Equation 7$$

where
E′: storage modulus/real modulus (GPa)
E″: loss modulus/imaginary modulus (GPa)
δ: phase lag parameter
η: damping or loss factor

$$f = {f}_{0} exp ( \frac{- Δ H}{R T} ) \qquad Equation 8$$

where
f frequency (Hz)
f₀ frequency constant for material (Hz)
ΔH activation energy for process
R gas constant
T temperature (° K)

1. A method of making a bending wave acoustic radiator for a loudspeaker, the acoustic radiator having a bending stiffness which varies with frequency, the method comprising selecting the variation of the bending stiffness such that the bending stiffness is lower at low frequencies and higher at high frequencies to effect a desired acoustic output from the loudspeaker, and making the acoustic radiator having said selected variation.

2. A method according to claim 1, comprising selecting an acoustic radiator having a component made from a frequency dependent material which has a glass to rubber transition in the operative frequency range of the speaker.

3. A method according to claim 2, comprising modifying the frequency dependent material to adjust the frequency at which the transition occurs.

4. A method according to claim 3, wherein the material is a polymer and the method comprises modifying at least one of the parameters in the group consisting of molecular weight, molecular distribution, steric effects, polarity of side group and crosslink density.

5. A method according to any one of claims 1 to 4, comprising selecting the variation in bending stiffness to have a relatively sharp transition at a selected point in the frequency range.

6. A method according to claim 5, wherein the frequency dependent material is selected from the group consisting of viscoelastic material, resins, thermoplastic polymers, foamed material and polymer blends.

7. A method according to claim 6, wherein the frequency dependent material is a polymeric material which encapsulates a fibre reinforcement having a higher modulus which is independent of frequency.

8. A method according to claim 7, wherein the frequency dependent material is a polymeric material which encapsulates a second material having a higher mass which is independent of frequency.

9. A method according to any one of claims 1 to 4, wherein the frequency dependent material is selected from the group consisting of viscoelastic material, resins, thermoplastic polymers, foamed material and polymer blends.

10. A method according to claim 9, wherein the frequency dependent material is a polymeric material which encapsulates a fibre reinforcement having a higher modulus which is independent of frequency.

11. A method according to claim 10, wherein the frequency dependent material is a polymeric material which encapsulates a second material having a higher mass which is independent of frequency.

12. A method of making an acoustic member for a loudspeaker having an operative frequency range and an acoustic output which depends on the values of physical parameters of the member that include damping, the acoustic member being in the form of a compliant suspension between a coil and magnet assembly of a moving coil transducer, the suspension having a damping which varies with frequency, the method comprising selecting the damping to have a high value at a specific frequency whereby a resonance at that specific frequency is damped, and making the member having said selected variation of damping.

13. A method of making an acoustic member for a loudspeaker having an operative frequency range and an acoustic output which depends on the values of physical parameters of the member that include damping, the acoustic member being in the form of a mass coupled to at least one resonant bending wave mode in an acoustic radiator, the mass having a damping which varies with frequency, the method comprising selecting the damping of the mass to be high at low frequency and low at high frequency, and making the member having said selected variation of damping.

14. An acoustic member for a loudspeaker having an operative frequency range, wherein the member comprises a component made from a frequency dependent material having at least one parameter which varies as a function of frequency.

15. An acoustic member according to claim 14, wherein the parameter is selected from the group consisting of damping, bending stiffness, Young's modulus, tension modulus, compression modulus and shear modulus.

16. An acoustic member according to claim 14 or claim 15, having a composite structure comprising at least one component having a frequency dependent parameter.

17. An acoustic member according to claim 16, comprising a core of low density material and two skins adhered by adhesive layers to opposed faces of the core, the skins having stiffness increasing with frequency.

18. An acoustic member according to claim 14, wherein the acoustic member is a suspension for attaching the loudspeaker on a support, stand or wall.

19. An acoustic member according to claim 14, wherein the loudspeaker is a bending wave loudspeaker comprising an acoustic radiator which supports bending wave vibration and a transducer mounted by a suspension to the acoustic radiator to excite bending wave vibration in the radiator to produce an acoustic output and the acoustic member is selected from the group consisting of the acoustic radiator, the transducer suspension, a suspension which supports the radiator in a frame or masses mounted on the acoustic radiator.

20. An acoustic member according to claim 19, wherein the acoustic member is a bending wave acoustic radiator having lower bending stiffness at low frequencies and higher bending stiffness at high frequencies.

21. An acoustic member according to claim 20, wherein the bending stiffness has a relatively sharp transition at a selected point in the frequency range.

22. An acoustic member according to claim 19, wherein the transducer is a moving coil transducer having a coil and magnet assembly and the acoustic member is in the form of a compliant suspension between the coil and magnet assembly and has high damping at a specific frequency whereby a resonance at that specific frequency is damped.

23. An acoustic member according to claim 19, wherein the acoustic radiator has a distribution of resonant bending wave modes and the acoustic member is in the form of a mass coupled to at least one specific mode in the acoustic radiator, the mass having high damping at low frequency and low damping at high frequency.

24. An acoustic member according to claim 19, in the form of an acoustic radiator having frequency dependent material applied at specific positions inside the structure of the acoustic radiator.

25. An acoustic member according to claim 19, in the form of a radiator suspension extending around the perimeter of a bending wave acoustic radiator, the suspension having low damping and low compliance at higher frequencies and high damping and high compliance at lower frequencies.

26. An acoustic member according to claim 19, in the form of a monolithic bending wave panel formed from a material having a Young's modulus which is lower at low frequency and higher at high frequency.

27. An acoustic member according to claim 19, in the form of an acoustic radiator which tapers across at least one dimension.

28. An acoustic member according to claim 27, wherein the central region of the acoustic radiator is stiff and the edge region has higher compliance whereby the acoustic radiator acts both as an acoustic radiator and an edge suspension to a supporting frame.

29. An acoustic member according to claim 14, wherein the loudspeaker is a pistonic loudspeaker comprising an acoustic radiator in the form of a cone mounted on a frame by a compliant edge termination, a drive unit supported on the frame by a spider and an enclosure housing the cone and drive unit and the acoustic member is selected from the group consisting of the spider, the compliant edge termination, the cone or a compliant suspension which bonds the drive unit to the enclosure.

30. An acoustic member according to claim 29, in the form of the compliant edge termination around the cone, the termination having high compliance at low frequencies and a lower compliance at high frequencies.

31. An acoustic member according to claim 29, in the form of the cone and having high damping at low frequency and enhanced stiffness at higher frequencies.

32. An acoustic member according to claim 14, wherein the frequency dependent material has a glass to rubber transition in the operative frequency range of the speaker.

33. An acoustic member according to claim 32, wherein the acoustic member has separate regions each having transitions at different frequencies.

34. An acoustic member according to claim 14, wherein the frequency dependent material is selected from the group consisting of viscoelastic material, resins, thermoplastic polymers, foamed material and polymer blends.

35. An acoustic member according to claim 14, wherein the frequency dependent material is a polymeric material which encapsulates a fibre reinforcement having a higher modulus which is independent of frequency.

36. An acoustic member according to claim 14, wherein the frequency dependent material is a polymeric material which encapsulates a second material having a higher mass which is independent of frequency.
